(19) United States
(12) Patent Application Publication
(10) Pub. No.: US 2024/0178421 A1
(43) Pub. Date: May 30, 2024

(54) FUEL CELL SYSTEM

(71) Applicant: CERES INTELLECTUAL PROPERTY COMPANY LIMITED, Horsham West Sussex (GB)

(72) Inventors: Alexander MCNICOL, Horsham, West Sussex (GB); Oliver POSTLETHWAITE, Horsham, West Sussex (GB); Jonathan David HARMAN, Horsham, West Sussex (GB); Stefano MICUCCI, Horsham, West Sussex (GB); Farzad BARARI, Horsham, West Sussex (GB); Anupama PILLAI, Horsham, West Sussex (GB); Michael James MCLORN, Horsham, West Sussex (GB)

(21) Appl. No.: 18/548,271

(22) PCT Filed: Mar. 1, 2022
(86) PCT No.: PCT/EP2022/055150

§ 371 Date: Aug. 29, 2023

(30) Foreign Application Priority Data
Mar. 3, 2021 (GB) 2102985.5

(51) Int. Cl. H01M 8/04746; C01B 3/38; H01M 4/90; H01M 8/04089; H01M 8/04223; H01M 8/04225; H01M 8/04228; H01M 8/04302; H01M 8/04303; H01M 8/0432; H01M 8/04701; H01M 8/04858; H01M 8/04955; H01M 8/0612; H01M 8/0637; H01M 8/12; H01M 8/126; H01M 8/2425

(52) U.S. Cl. CPC H01M 8/04753; C01B 3/38; H01M 4/9033; H01M 8/04097; H01M 8/04225; H01M 8/04228; H01M 8/04268; H01M 8/04302; H01M 8/04303; H01M 8/0432; H01M 8/04701; H01M 8/0488; H01M 8/0491; H01M 8/04955; H01M 8/0618; H01M 8/0637; H01M 8/126; H01M 8/2425; C01B 2203/0233; C01B 2203/067; C01B 2203/0894; H01M 2008/1293

(57) ABSTRACT

A fuel cell system (200, 300) and a method for operating the fuel cell system (200, 300). The fuel cell system (200, (1300) comprising an anode inlet (226) and an anode outlet (227); means for heating the stack (205); an anode off gas recirculation loop (240) configured to provide a gas flow path to recirculate anode off gas from the anode outlet (227) to the anode inlet (226); and a controller (290). The method comprising, at start-up of the fuel cell system (200, 300); heating the stack (205) to a first threshold temperature; providing an unreformed hydrocarbon fuel to the anode inlet (226) at a first fuel flow rate from a fuel supply (225) when but not before the stack (205) is above the first threshold temperature; recirculating anode off gas from the anode outlet (227) to the anode inlet (226) while providing unreformed fuel to the anode inlet (226); and drawing a current from the fuel cell system (200, 300) while recirculating the anode off gas.

### FIELD OF THE INVENTION

The present invention relates to fuel cell systems and methods, and in particular to start-up and shut-down of fuel cell systems.

### BACKGROUND TO THE INVENTION

Teachings of fuel cells, fuel cell stacks, fuel cell stack assemblies, and heat exchanger systems, arrangements and methods are well known to one of ordinary skill in the art, and in particular include WO2015004419A of the Applicant, which is incorporated herein by reference in its entirety. Definitions of terms used herein can be found as necessary in the above publication. In particular, the present invention seeks to improve the systems and methods disclosed in WO2015004419A.

The present invention is directed at a fuel cell system and method of operation of that system in which a hydrocarbon fuel is provided to an anode inlet of a fuel cell stack.

A typical fuel cell converts chemical energy in the form of a fuel and an oxidant to electrical energy. The fuel used by the fuel cell may be hydrogen gas, and the oxidant oxygen, and exhaust gasses are limited to water. It is preferable to operate a fuel cell system on natural gas, in which case the natural gas may be reformed to hydrogen in the fuel cell system. To do so requires a supply of water to reform the natural gas to hydrogen.

Operating hydrocarbon fuelled fuel cell (for example a SOFC (solid oxide fuel cell)) systems where the fuel cell stack operates in the 450-650 DegC range (intermediate-temperature solid oxide fuel cell; IT-SOFC), more particularly in the 520-620 DegC temperature range, results in a challenging set of technical problems being encountered.

In such systems, steam reforming at a reformer is typically used to convert a hydrocarbon fuel stream (such as natural gas) into a hydrogen-rich reformate stream which is fed to the fuel cell stack anode inlet. WO2015004419A discloses one such system in which a hydrocarbon fuel is reformed into a hydrogen-rich reformate stream before delivery to an anode inlet of the stack. In such systems, a supply of steam is provided to reform the hydrocarbon fuel in the reformer. This necessitates a water supply (for example a tank) and means to heat liquid water to steam, which can be used at start-up (e.g. from ambient temperature) and during steady state operation (i.e. when current is being drawn from the fuel cell system at operating temperature). When a fuel cell system is in use at steady state, the fuel cell itself produces water, which is removed from the stack and could be used in the reformer. Systems sometimes utilise a condenser to separate water from off gas for replenishment of a water tank and subsequent use in a reformer.

A typical start-up sequence (for example from ambient temperatures) involves heating the stack and reformer and supplying a steam/fuel stream to the reformer and stack for a period of time before drawing current from the stack. The steam is supplied to the reformer via a separate de-ionized water supply and steam generator. This allows a steam/methane reforming (SMR) reaction to occur within the reformer, releasing hydrogen for the fuel cell reaction and providing a reducing atmosphere over the anode to prevent oxidation of the anode. Presence of steam in the supply to the reformer provides conditions that are thermodynamically unfavourable to carbon deposition reactions within the reformer (and in the stack). Carbon deposition reactions include the Bouduard reaction (2CO<->CO2+C), CO Reduction (H2+CO<->H2O+C), and methane cracking (CH4<->2H2+C). These reactions can lead to build up of carbon, which over the lifetime of a system is likely to lead to de-activation of the fuel cell anode and/or reforming catalysts and result in possible blockages of fuel supply channels. This in turn leads to fuel starvation. Start-up and steady state conditions in fuel cell systems are usually designed to avoid these carbon deposition reactions. The rate of carbon deposition from these reactions is lower at lower temperature, however other problems arise at lower temperatures. For example potentially hazardous nickel-tetracarbonyl (NiCO4) may form if hydrocarbon fuels are flowed over nickel-containing components in the fuel cell system.

Some fuel cell systems have been proposed in which the water tank and means to heat liquid water to steam are removed. Some of these systems use a partial oxidation (POX) reactor in addition to a reformer to produce a hydrogen-rich stream from a hydrocarbon fuel supply for delivery to an anode inlet. JP2012243564 is an example of such a system, in which a hydrocarbon fuel supply is partially oxidised in a POX reactor using an oxidant to produce molecular hydrogen and carbon monoxide. In JP2012243564 the output of the POX reactor is fed into a steam reformer and subsequently to the anode inlet of the stack. Such systems utilise the POX reactor at start-up because it does not require a water supply. In JP2012243564, the hydrogen produced by the POX during start-up of the system is utilised by the fuel cell stack, and water produced therein may be recirculated to the POX reactor and steam reformer to reform hydrocarbon fuel. This allows start-up without a water supply but necessitates a POX reactor. US2005181247A, WO03092102, and WO03065488 are further examples of similar systems which use the reformer as a POX reactor during start-up, in some cases with an external steam supply.

Other systems, such as DE102009053839 and JP2009099264, start up by directing hydrocarbon fuel from the source to a combustor (e.g. a burner) and utilise water in the combustion products in a reformer to reform hydrocarbon fuel to hydrogen for delivery to an anode of the fuel cell stack.

US 2018/145351 A1 relates to a shut-down procedure of a fuel cell system. US 2018/145351 A1 seeks to reduce anode oxidation and carbon deposition during shutdown of the fuel cell system using a relationship between a fuel flow rate and a steam flow rate (the fuel and steam mixed and supplied to an anode via and anode recirculation loop), a current drawn from the fuel cell stack, and a temperature of the fuel cell stack. The steam is supplied from a source external to the fuel cell system. Anode off gasses from the anode of the fuel cell stack are returned to the pipe conveying the fuel and steam, and mixed with the same. A portion of the mixed gases are provided to the anode inlet by the anode recirculation loop, and the remainder is discharged from the fuel cell system as exhaust. The portion is not part of the relationship used to reduce anode oxidation and carbon deposition during shutdown.

Some systems utilise a temporary supply of hydrogen for start-up of a fuel cell system. DE102013226305 provides one such example. It provides a metal hydride storage tank in which hydrogen is stored for use on start-up of the fuel cell system. FIG. 1 is drawn from DE102013226305. FIG. 1 shows a fuel cell system 10 comprising a hydrocarbon fuel supply 20, reformer 14, metal hydride storage tank 24, and a fuel cell 12. Fuel is supplied to an anode side of the fuel cell at anode inlet 18. Anode off gas may be recirculated 28 from an anode outlet of the fuel cell 12 to the reformer 14 via an exhaust gas recirculation line 26. The fuel supplied to the anode inlet 18 may be switched using valves 32 between a reformed hydrocarbon supply from the reformer and a hydrogen supply from the metal hydride storage tank 24 via a pump 34. During start-up of the fuel cell system of FIG. 1, hydrogen from the metal hydride storage tank 24 is supplied to the fuel cell. Anode off gas is recirculated to the reformer where its water content may be used for reforming of hydrocarbon fuel, that reformed fuel being delivered to the anode inlet 18 of the fuel cell during steady state operation. Some of the anode off gas may be expelled from the system via outlet 22.

It is an aim of the present invention to reduce the number of components required in a fuel cell system and thereby reduce size, weight and/or cost.

The present invention seeks to address, overcome or mitigate at least one of the prior art disadvantages.

### SUMMARY OF THE INVENTION

In accordance with a first aspect there is provided a method for operating a fuel cell system, the fuel cell system comprising a plurality of cell units arranged in a stack, each cell unit comprising an anode and a cathode separated by an electrolyte, and the fuel cell system comprising an anode inlet for supply of anode inlet gas to each cell unit and an anode outlet for removal of anode off gas from each cell unit, the method comprising, at start-up of the fuel cell system: heating the stack to a first threshold temperature; providing an unreformed hydrocarbon fuel to the anode inlet at a first fuel flow rate from a fuel supply when but not before the stack is above the first threshold temperature; recirculating anode off gas from the anode outlet to the anode inlet while providing unreformed fuel to the anode inlet; and drawing a current from the fuel cell system while recirculating the anode off gas.

The method of start-up of the fuel cell system allows start-up using an unreformed hydrocarbon fuel without use of an external (to the stack) reformer, water supply, partial oxidation reactor, or combustor. This significantly reduces the number of components in the fuel cell system and thereby reduces cost and complexity.

The method allows drawing of a current from the fuel cell system early in the start-up method. Drawing current means that the fuel cell reaction is ongoing and is producing water, as one of the by-products. This water may reduce the rate of carbon formation (e.g. as it passes through the rest of the fuel cell or is recirculated in the anode off gas). Typically, in the case of an electrolyte that allows oxygen ion transport, the water will be produced at the fuel side (i.e. the anode side) of the electrolyte and reduces carbon deposition.

Providing the unreformed hydrocarbon fuel to the anode inlet and recirculating the anode off gas from the anode outlet to the anode inlet allows the fuel cell system to start-up (i.e. begin operation from a dormant or cold state) without use of a hydrogen fuel supply to the anode inlet. A dormant state may be a standby state in which the stack is held above a minimum temperature. A cold state may be at ambient temperature.

Fuel cell systems typically contain components which act to crack hydrocarbon fuels upon application of heat. Most fuel cell systems which use a hydrocarbon fuel add steam to a hydrocarbon fuel to seek to avoid cracking due to the associated carbon deposition, but in this case cracking is advantageous, since it allows production of hydrogen for use at the anode of each cell unit. Thus, hydrogen may be produced for use in the fuel cell reaction without the use of a supply of steam. Test data shows reliable start-up using the method of the first aspect with negligible carbon build up in the stack over 500 cycles.

Current is drawn from the fuel cell (i.e. from the stack of cell units) while recirculating the anode off gas to the anode inlet and while providing unreformed hydrocarbon fuel to the anode inlet. At this time, each cell unit is operating according to the electrochemical fuel cell reaction, thereby producing water at the anode. The water is in the form of steam. This water is a component of the anode off gas and so is provided to the anode inlet by recirculating the anode off gas and to the cell units within the stack where that water (steam) may be used in reforming unreformed hydrocarbon fuel to hydrogen (and carbon monoxide) for use by the cell units. The recirculating may be started before beginning to draw current, simultaneously with beginning to draw current, or shortly after starting to draw current. The recirculating may be started before beginning to draw current in order to minimise the time any steam that is created takes to reach the anode.

Water is produced by the stack as a result of being able to draw current. The water is produced in the form of steam, and that steam is recirculated from the anode outlet to the anode inlet. In other words, this returns water produced by fuel cell units to the stack, which may include various components that catalyse steam reforming to reform the unreformed hydrocarbon fuel to hydrogen, which in turn is used by the fuel cell units to provide current. This means that all water used for reforming fuel in the stack is produced in the stack, no source of water (for example a water tank, condenser, and/or external supply of water with purification means) is required for steam reforming.

Similar to the unreformed hydrocarbon fuel provided to the anode inlet, the anode off gas recirculated from the anode outlet to the anode inlet does not pass through a reformer. Similarly, the anode off gas recirculated from the anode outlet to the anode inlet does not pass through a combustor nor partial oxidation reactor.

The recirculating of anode off gas from the anode outlet to the anode inlet while providing unreformed fuel to the anode inlet means that the fluid provided to the anode inlet is a mixture of unreformed hydrocarbon fuel and anode off gas.

The first threshold temperature is chosen such that the unreformed hydrocarbon fuel is provided to the anode inlet once the temperature of the stack is above that at which NiCO4 may be formed. The first threshold temperature is also at or above the temperature at which minimum current can be drawn from the fuel cell without the fuel cell voltage being pulled below a voltage at which damage may occur to the fuel cell (specifically the anode, electrolyte, and cathode).

Providing the unreformed hydrocarbon fuel to the anode inlet as soon as but not before the stack is above the first threshold temperature minimises the time period during which oxidation of the anode can occur. This also ensures that the unreformed hydrocarbon fuel is first supplied to the anode inlet at temperatures at which the reaction rates of the carbon forming reactions are low, and current draw begins (thereby producing steam) and this prevents significant build-up of carbon within the stack and other components.

The first threshold temperature may be such that the hydrocarbon fuel is cracked to hydrogen and carbon in the presence of a catalyst in the stack. Sufficient catalyst is present in the stack to allow cracking at the rate required to produce hydrogen and enable current draw from the fuel cell system. Various materials suitable for catalysing cracking are typically present in the fuel cell system. For example, nickel may catalyse cracking and may be present in the anode and in metal support plates supporting the anode, electrolyte, and cathode, and in interconnects and separators between cell units. The stack may comprise a catalyst for purposes of internal reforming, the same catalyst may also catalyse cracking.

The unreformed hydrocarbon fuel provided during start-up to the first threshold temperature may also be referred to as a pure hydrocarbon fuel (for example by not having substantial amounts of added hydrogen, oxygen, water, carbon monoxide, or carbon dioxide). The unreformed fuel may be supplied with a minority proportion (e.g. 10%) of hydrogen. In each case, the unreformed hydrocarbon fuel is provided to the anode inlet without passing through a reformer or a combustor. The unreformed hydrocarbon fuel may comprise one or more of natural gas, methane, ethane, propane, butane, corresponding alcohols, and biogas.

The skilled person will understand that the stack may be heated to the first threshold temperature using one or more of different methods. For example, an electric heater may be used to heat the stack. Alternatively fuel may be combusted in a burner and used to indirectly provide heat to the stack (typically via one or more heat exchangers). The burner may be a burner which is also used to combust unused fuel and oxidant in anode off gas and cathode off gas, respectively, during operation of the fuel cell system.

The fuel cell system may also comprise a cathode inlet for supply of cathode inlet gas to each cell unit and a cathode outlet for removal of cathode off gas from each cell unit. The cathode inlet gas may be an oxidant, for example air. The cell units may comprise a planar substrate (or metal support plate) and a separator (or interconnect) and may be similar to those described in the Applicant's earlier patent application WO 2015/136295. The substrate carries an electrochemically active layer (or active fuel cell component layer) comprising the respective anode, electrolyte and cathode layers. These layers may be respectively deposited (e.g. as thin coatings/films) on and supported by the metal support plate (e.g. steel plate or foil), the electrochemically active layer may face the separator of an adjacent cell unit. The metal support plate may have a porous region surrounded by a non-porous region with the active layers being deposited upon the porous region so that gases may pass through the pores from one side of the metal support plate to the opposite side to access the active layers coated thereon.

The method may involve monitoring the stack temperature; this may be measured directly or indirectly. The method may involve controlling the mixture ratio of unreformed hydrocarbon fuel and anode off gas. The fuel flow rate of unreformed hydrocarbon fuel to the anode inlet is increased as the stack temperature increases.

Preferably, the method further comprises monitoring the stack temperature, and when the stack temperature reaches a second threshold temperature, greater than the first threshold temperature, increasing the fuel flow rate of the unreformed hydrocarbon fuel and current draw.

This allows the current draw and stack temperature to be increased stepwise toward steady state operating conditions. Steady state operation may be characterised by a steady state stack temperature in the range of 400 to 1000 C, preferably 450 to 800 C, more preferably 500 to 650 C, and additionally or alternatively by one or more of a steady state voltage in the range 0.8 to 1.0V and a steady state current density in the range 0.05 to 1.5 A/cm², preferably 0.05 to 0.3 A/cm², more preferably 0.1 to 0.25 A/cm². Providing fuel allows electrochemical reaction in each fuel cell unit to begin, thereby allowing current to be drawn, and thereby increasing the temperature of the system. As the fuel flow rate of the unreformed hydrocarbon fuel increases, so too may the current draw and the temperature of the stack. As the temperature of the stack increases, the cell units are able to utilise more fuel, and thereby provide greater current.

Carbon deposition in the stack (at the anode side of the cell units) is typically governed by the ratio of oxygen to carbon in the fuel. A low O:C ratio leads to carbon deposition, for example by cracking. The fuel cell produces water at the anode side, which increases the O:C ratio for a given fuel flow rate of unreformed hydrocarbon fuel. The rate at which the fuel cell produces water is related to its current draw. Increased current draw allows greater availability of O2 for fuel cell reaction. As the fuel cell increases in temperature towards steady state operation, the fuel cells are able to utilise an increasing proportion of the unreformed hydrocarbon fuel and thereby produce increasing amounts of water. Each time the fuel flow rate of the unreformed hydrocarbon fuel is increased, the O:C ratio is lowered. Therefore, increasing the fuel flow rate of the unreformed hydrocarbon fuel and the current draw when the stack temperature reaches a second threshold temperature allows the method to increase the O:C ratio at a rate to minimise carbon deposition.

The O:C ratio may be inferred from stack temperature, flow rate of anode off gas from the anode outlet to the anode inlet, flow rate of unreformed hydrocarbon fuel, and current draw.

Additionally or alternatively, the method is configured to control the fuel flow rate of the unreformed hydrocarbon fuel, flow rate of anode off gas from the anode outlet to the anode inlet, and current draw to bring the ratio of oxygen to carbon in the stack up to above 2 (preferably above 2.2) in a target time period. The target time period is sufficiently short such that any detrimental effect from lack of oxygen can be substantially recovered during steady state operation and/or on shutdown. This may be done while maintaining the voltage of the fuel cell above a threshold voltage, the threshold voltage may be between 0.6 and 0.8V, preferably between 0.7 and 0.8V, more preferably 0.75V.

Preferably, the method includes increasing the fuel flow rate of the unreformed hydrocarbon fuel and increasing the current draw in incremental steps at corresponding incrementally increasing stack temperatures. The step size can be as small as the measurement and control allows. In other words, the increase can be continuous, with control feedback governed by voltage, such that the current is increased without allowing the voltage to drop below its preferred minimum.

This allows the current draw and stack temperature to be increased stepwise toward steady state operating conditions, while maintaining the voltage above a threshold, increasing the O:C ratio, and subsequently maintain the O:C ratio above a threshold while continuing to approach steady state operating conditions.

Preferably, the method further comprises reducing the flow rate of anode off gas from the anode outlet to the anode inlet as the stack temperature increases above the first threshold temperature.

For example, at the first threshold temperature recirculating anode off gas from the anode outlet to the anode inlet may begin with a first flow rate. At the second threshold temperature, the flow rate of recirculating anode off gas from the anode outlet to the anode inlet may be decreased. Repeat with subsequently increasing temperatures (for example subsequent temperature thresholds) until steady state operating conditions (for example current, voltage, and/or temperature) are reached. As temperature and fuel utilisation are increased, the fuel cell system is able to utilise a greater proportion of the unreformed hydrocarbon fuel provided to the anode inlet, and so the proportion of unused fuel in the anode off gas decreases. Further, as the fuel utilisation increases, the O:C ratio may be maintained at a level that minimises carbon deposition by water, CO and CO2 produced at the cell units, and with decreasing reliance on water, CO, CO2 recirculated from the anode outlet.

Preferably, recirculating of the anode off gas when the temperature is above the first threshold temperature comprises recirculating up to 80% of the anode off gas, more preferably up to 70% of the anode off gas. If more than 80% of the anode off gas were recirculated, then CO2 and steam may build up in the system, detracting from performance of the start-up procedure and limiting current draw.

Preferably, the current is drawn while maintaining voltage of the fuel cell above a voltage threshold. The threshold voltage is set to prevent damage to the electrochemically active layers (i.e. the anode, electrolyte, and cathode). Electrochemically active layers typically allow current draw at a variety of voltages, but if current is drawn below a certain voltage then damage may be caused to the electrochemically active layers. The voltage threshold ensures damage to the electrochemically active layers is avoided, while also being set to a level that enables current draw at low operating temperatures, thereby providing oxygen to the anode side of the electrolyte, and so allowing the anode to produce oxygen-containing compounds (i.e. water/CO/CO2) from low temperature.

Preferably, the voltage threshold is between 0.6 and 0.8V. This provides a balance between avoiding damage to the electrochemically active layers and providing current at low temperature (and thereby providing oxygen-containing compounds at the anode to increase the O:C ratio). This may allow the O:C ratio to exceed 2 (preferably 2.2) in a minimal number of steps, for example 2 steps, and to maintain the O:C ratio above 2 (preferably above 2.2) as the fuel flow rate of the unreformed hydrocarbon fuel and current draw are increased towards steady state. Preferably the voltage threshold is between 0.7 and 0.8V, more preferably 0.75V.

Preferably, at least one of the anode and the electrolyte comprises ceria (cerium oxide). The ceria may be reduced from Ce4+ to Ce3+ during the start-up procedure. Without being limited by theory, it is believed that the ceria acts as an oxygen source, increasing the O:C ratio and reducing carbon formation. The oxygen released by the ceria also produces steam in the stack via reaction with H2 from cracked hydrocarbon. The steam gives rise to steam reforming of the unreformed hydrocarbon fuel to molecular hydrogen for use by the fuel cell system. Ceria thus allows the fuel cell system to be started without a supply of water or hydrogen to the anode side with minimal carbon deposition at the first threshold temperature. When the O:C ratio increases, the ceria may be oxidised to Ce4+, alternatively or additionally, the ceria may be oxidised during a shutdown procedure.

Preferably, the electrolyte is of a type which allows oxygen ion transport, for example a solid oxide fuel cell (SOFC). Water is generated at the anode during fuel cell operation using an electrolyte which allows oxygen ion transport.

Preferably, the anode comprises cerium-gadolinium oxide (CGO). CGO may allow the fuel cell system to supply current at a relatively low first threshold temperature.

Preferably, the anode comprises nickel. This may catalyse cracking of the unreformed hydrocarbon fuel to produce hydrogen for use by the fuel cell system at the first threshold temperature. Other components in the fuel cell system may also comprise nickel and thereby catalyse cracking of the unreformed hydrocarbon fuel to produce hydrogen. The other components may, for example, include a metal support plate upon which the electrochemically active layers are coated or deposited, or a separator or interconnect plate to separate adjacent cell units.

Preferably, the electrolyte comprises cerium-gadolinium oxide (CGO). CGO may allow the fuel cell system to supply current at a relatively low first threshold temperature.

Preferably, the unreformed hydrocarbon fuel provided during start-up above the first threshold temperature has the same composition as the unreformed hydrocarbon fuel provided to the anode inlet during steady state operation. In other words, no separate reformer, water, or hydrogen supply is required for start-up.

Preferably, the first threshold temperature is in the range 400 to 500 C, more preferably 400 to 450 C.

This is above the temperature at which NiCO4 would form in the presence of a hydrocarbon fuel and is a temperature at which the fuel cell reaction may begin (i.e. to allow current draw). In other words, this is a temperature where minimum current can be drawn without pulling the fuel cell voltage below minimum limits. The first threshold temperature is also at a temperature at which the reaction rates of the carbon forming reactions are relatively low and so prevents significant build-up of carbon within the stack or other components. The unreformed hydrocarbon fuel is provided when the first threshold temperature is reached, and the first threshold temperature may also be set such that the unreformed hydrocarbon fuel is provided before significant anode oxidation occurs.

The skilled person will understand that the stack may be heated to the first threshold temperature using one or more of different methods. For example, an electric heater may be used to heat the stack. Alternatively fuel may be combusted in a burner and used to indirectly provide heat to the stack (typically via one or more heat exchangers). The burner may be a burner which is also used to combust unused fuel and oxidant in anode off gas and cathode off gas, respectively, during operation of the fuel cell system.

Preferably, the temperature of the stack is identified by measuring the anode off gas temperature and/or the anode inlet gas temperature. Typically, a cathode off gas temperature measurement (for example by use of a thermocouple placed close to the cathode outlet from the stack) is used as an indication of the minimum temperature within the stack, because the temperature during start-up of the anode and cathode inlets are typically hotter than the respective outlets. Alternatively or additionally, the anode off gas temperature may be measured as an indication of the temperature within the stack during start-up (for example by use of a thermocouple placed close to the anode outlet from the stack).

Preferably, the step of providing unreformed hydrocarbon fuel at a first fuel flow rate comprises providing unreformed hydrocarbon fuel at a rate which provides distribution across all cell units in the stack. This ensures that all cell units within the stack are provided with unreformed hydrocarbon fuel, thus allowing current draw from all the cell units. Thereby, temperature and other conditions are similar for each cell unit.

Preferably, recirculating anode off gas provides water produced by the stack to the anode inlet of the stack, and the method comprises reforming of the unreformed hydrocarbon fuel using the recirculated water at a reforming catalyst positioned between each cell unit and an adjacent cell unit. In other words, each cell unit may comprise a reforming catalyst, particularly a steam reforming catalyst (sometimes referred to as an internal steam reformer). The amount of reforming catalyst within the stack (e.g. within each cell unit) is sufficient to catalyse reformation of the unreformed hydrocarbon fuel, for instance when the unreformed hydrocarbon fuel is provided at a fuel flow rate corresponding to steady state operation.

Water is produced by the stack as a result of being able to draw current. The water is produced in the form of steam, and that steam is recirculated from the anode outlet to the anode inlet. In other words, this returns water produced by fuel cell units to an internal steam reformer, which reforms the unreformed hydrocarbon fuel to hydrogen, which in turn is used by the fuel cell units to provide current. This means that all water used for reforming fuel in the stack is produced in the stack, no source of water (for example a water tank, condenser, and/or external supply of water with purification means) is required for steam reforming.

Similar to the unreformed hydrocarbon fuel provided to the anode inlet, the anode off gas recirculated from the anode outlet to the anode inlet does not pass through a reformer. Similarly, the anode off gas recirculated from the anode outlet to the anode inlet does not pass through a combustor or partial oxidation reactor.

Preferably, each cell unit in the stack is separated from an adjacent cell unit by an interconnect structure, the interconnect structure having a coating on a side facing and in fluidic communication with the anode of the adjacent cell unit, the coating comprising the reforming catalyst and configured to reform fuel to hydrogen for use in the stack. Preferably, the reforming catalyst is a steam reforming catalyst, for example platinum and/or rhodium. This catalyst may also catalyse cracking during start up above the first threshold temperature when negligible water is present.

Preferably, the method further comprises a shutdown procedure, the shutdown procedure comprising reducing the stack temperature and increasing the flow rate of anode off gas from the anode outlet to the anode inlet.

The shutdown procedure reduces the temperature of the fuel cell system in a controlled manner. The shutdown procedure may reverse the steps of the start-up procedure, and may allow re-oxidisation of any ceria that was reduced in the start-up procedure. Alternatively, the ceria may re-oxidise either during steady state operation or by diffusion of oxygen from atmospheric air once the system is cool.

As the stack temperature is reduced, the amount of steam produced by the fuel cell reaction decreases. As a result, the flow rate of anode off gas from the anode outlet to the anode inlet may be increased (and hence the ratio of recirculated anode off gas to unreformed hydrocarbon fuel at the anode inlet is increased) to maintain the O:C ratio within the stack.

Preferably, reducing the stack temperature in the shutdown procedure comprises reducing the fuel flow rate of the unreformed hydrocarbon fuel and the current draw, while maintaining the fuel flow rate of the unreformed hydrocarbon fuel and current draw above a threshold value.

The system can be stopped by removing the flow rate of unreformed hydrocarbon fuel to the cells (for example, removing by changing the fuel flow rate to zero, in an emergency), but this would likely cause a redox cycle of at least the anode. The shutdown procedure ensures the cells receive a reducing fuel stream until the anode is no longer active. In contrast, fuel cell systems typically require a dedicated steam supply for use during shutdown in order to avoid a redox cycle. Current draw is maintained to maintain the O:C ratio above 2 (preferably 2.2) and thereby prevent carbon formation.

Preferably, the shutdown procedure further comprises stopping the unreformed hydrocarbon fuel supply when, but not before, the stack temperature is below the first threshold temperature.

This prevents NiCO4 formation while the stack continues to cool. The first threshold temperature is the same temperature as the first threshold temperature used during start-up (i.e. in the range 400-500 C, preferably 400-450 C).

For purposes of systems safety, the fuel cell system may be purged with a purge gas at shutdown and/or at start-up, but in the present system a purge is not necessary to prevent carbon formation. Alternatively, the shutdown procedure may comprise stopping the hydrocarbon fuel supply while recirculating AOG, when the stack temperature is above the first threshold temperature and below a third threshold temperature.

Without being limited by theory, it is believe that this may initiate re-oxidation of ceria, if the ceria was reduced during start-up. For example, the third threshold temperature may be around 50 C higher than the first threshold temperature (e.g., if the first threshold temperature is in the range of 400-450 C, the third threshold temperature is in the range 450-500 C).

In accordance with a second aspect, there is provided a method for operating a fuel cell system, the fuel cell system comprising a plurality of cell units arranged in a stack, each cell unit comprising an anode and a cathode separated by an electrolyte, and the fuel cell system comprising an anode inlet for supply of anode inlet gas to each cell unit and an anode outlet for removal of anode off gas from each cell unit, the anode inlet gas comprising an unreformed hydrocarbon fuel and a portion of anode off gas removed from the anode outlet, the method comprising a shutdown procedure, comprising: drawing current from the fuel cell system while providing unreformed hydrocarbon fuel to the anode inlet and reducing the stack temperature. Reducing the stack temperature preferably comprises reducing the fuel flow rate of the unreformed hydrocarbon fuel and/or reducing the current draw, while maintaining the fuel flow rate of unreformed hydrocarbon fuel supply to the anode inlet and current draw above a threshold value.

Preferably, the current draw and fuel flow rate of the unreformed hydrocarbon fuel are reduced stepwise (or continuously, under feedback control), thereby the stack temperature is reduced gradually until the first threshold temperature is reached. Continuous reduction under feedback control comprises reducing fuel without allowing the voltage to fall below the preferred minimum.

The method according to the second aspect may be combined with any of the features outlined for the first aspect above.

In accordance with a third aspect, there is provided a fuel cell system. The fuel cell system of the third aspect is configured for use in the method of the first and second aspects. The fuel cell system comprising: a plurality of cell units arranged in a stack, each cell unit comprising an anode and a cathode separated by an electrolyte, and the fuel cell system comprising an anode inlet for supply of anode inlet gas to each cell unit and an anode outlet for removal of anode off gas from each cell unit; means for heating the stack; means for measuring a temperature of the stack; a fuel inlet configured for connection to a supply of unreformed hydrocarbon fuel and configured to provide the unreformed hydrocarbon fuel to the anode inlet; an anode off gas recirculation loop configured to provide a gas flow path to recirculate anode off gas from the anode outlet to the anode inlet; means for drawing a current from the fuel cell system; and a controller configured to receive input from the means for measuring and provide output to the recirculation loop and to the means for drawing current, for controlling the recirculation loop, the supply of unreformed hydrocarbon fuel, and the means for drawing current, all in response to the means for measuring.

The fuel inlet is configured to provide unreformed hydrocarbon fuel to the anode inlet. In other words, the flowpath of a fuel from a fuel source to anode inlet does not pass through a reformer, combustor or partial oxidation reactor. Likewise, there is no reformer, combustor or partial oxidation reactor in the anode off gas recirculation loop. As a result, the fuel cell system is reduced in complexity and cost.

The controller may receive said inputs and provide said outputs in order to perform the method of the first and/or second aspect. The controller may provide unreformed hydrocarbon fuel and allow a corresponding current draw from the means for drawing a current that maintains the fuel cell voltage above the threshold voltage. During start-up, the controller may provide stepwise increases of flow rate of the unreformed hydrocarbon fuel and allow a corresponding stepwise increase of current draw from the means for drawing a current when the fuel cell system reaches a temperature (and thereby fuel utilisation) at which the stepwise increase may be made while maintaining the fuel cell voltage at some margin above the threshold voltage.

For example, the fuel cell voltage may be maintained above the threshold and within 15% (more preferably within 10%) of the threshold voltage during the start-up procedure. In other words, the fuel cell voltage may be maintained between the threshold voltage and a voltage 15% higher (preferably 10% higher) than the threshold during the start-up procedure. This ensures that the controller allows a greater fuel flow rate of unreformed hydrocarbon fuel once the fuel cell voltage reaches such a level that the greater fuel flow rate of hydrocarbon fuel may be tolerated, as such, improved start-up times are achieved.

The controller may infer an O:C ratio in the stack (i.e. at the anode side of each cell unit) from stack temperature, flow rate of anode off gas from the anode outlet to the anode inlet, flow rate of unreformed hydrocarbon fuel, and current draw. The controller may adjust one or more of said outputs to achieve one or more of the following: a) reach an O:C ratio greater than 2 (preferably 2.2) during start-up and b) maintain the O:C ratio greater than 2 (preferably 2.2) during steady state, and c) maintain the O:C ratio greater than 2 (preferably 2.2) during shutdown above the first threshold temperature.

All water in the fuel cell system is provided by the reaction at the fuel cell itself. In other words, there is no water tank or means configured to supply water to the system from an external source. As a result, the fuel cell system is reduced in complexity and cost.

The unreformed hydrocarbon fuel provided to the anode inlet may also be referred to as a pure (as previously defined) hydrocarbon fuel. The unreformed hydrocarbon fuel is provided to the anode inlet without passing through a reformer or a combustor. The unreformed hydrocarbon fuel may comprise one or more of natural gas, methane, ethane, propane, butane, corresponding alcohols, and biogas.

The fuel cell system may also comprise a cathode inlet for supply of cathode inlet gas to each cell unit and a cathode outlet for removal of cathode off gas from each cell unit. The cathode inlet gas may be an oxidant, for example air. The cell units may comprise a planar substrate (or metal support plate) and a separator (or interconnect) and may be similar to those described in the Applicant's earlier patent application WO 2015/136295. The substrate carries an electrochemically active layer (or active fuel cell component layer) comprising the respective anode, electrolyte and cathode layers. These layers may be respectively deposited (e.g. as thin coatings/films) on and supported by the metal support plate (e.g. steel plate or foil), the electrochemically active layer may face the separator of an adjacent cell unit. The metal support plate may have a porous region surrounded by a non-porous region with the active layers being deposited upon the porous region so that gases may pass through the pores from one side of the metal support plate to the opposite side to access the active layers coated thereon.

The means for measuring a temperature of the stack may comprise means for measuring an anode off gas temperature and/or a cathode off gas temperature. Typically, a cathode off gas temperature measurement (for example by use of a thermocouple placed close to the cathode outlet from the stack) is used as an indication of the minimum temperature within the stack, because the temperature during start-up the anode and cathode inlets are typically hotter than the respective outlets. Alternatively or additionally, the anode off gas temperature may be measured as an indication of the temperature within the stack during start-up (for example by use of a thermocouple placed close to the anode outlet from the stack).

The skilled person will understand that the means for heating the stack (for example a first threshold temperature) may comprise one or more of different means. For example, an electric heater may be used to heat the stack. Alternatively fuel may be combusted in a burner and used to indirectly provide heat to the stack (typically via one or more heat exchangers). The burner may be a burner which is also used to combust unused fuel and oxidant in anode off gas and cathode off gas, respectively, during operation of the fuel cell system.

The means for drawing a current may be a load that the fuel cell is configured to power, the controller may limit the current drawn by the load during start-up and shutdown.

Preferably, the anode off gas recirculation loop comprises means configured to vary the flow rate of anode off gas in the anode off gas recirculation loop, controlled by the controller in response to the means for measuring and the means for drawing a current.

The means configured to vary the flow rate of anode off gas in the anode off gas recirculation loop may comprise a variable splitter, pump or ejector configured to operate in the anode off gas recirculation loop (e.g. at “hot” temperatures above 500 C or “warm” temperatures above 120 C, so as to prevent condensation water in the anode off gas). Preferably, the means configured to control flow rate of anode off gas thereby recirculates a portion of the anode off gas from the anode outlet for delivery to the anode and the fuel cell system further comprises an exhaust gas flow path configured to remove a remaining portion of the anode off gas out of the fuel cell system from the anode outlet}

The controller may thereby control the O:C ratio in the fuel cell system by varying the flow rate of anode off gas in the anode off gas recirculation loop.

Preferably, the anode off gas recirculation loop further comprises a flowpath for anode off gas from the anode outlet, via a heater section, a mixing section configured to mix anode off gas with unreformed hydrocarbon fuel, and to the anode inlet.

The heater section may comprise at least one heat exchanger. The heater section may comprise a first heat exchanger configured to transfer heat from the anode off gas to the unreformed hydrocarbon fuel prior to the anode inlet. The heater section may comprise a second heat exchanger configured to transfer heat from the anode off gas to the oxidant to be provided to the cathode inlet. In examples where both the first and second heat exchangers are present, the second heat exchanger is subsequent to the first heat exchanger in the anode off gas recirculation loop.

Preferably, the fuel cell system further comprises a splitter subsequent to anode outlet and prior to mixing section to split a portion of the anode off gas into the anode off gas recirculation loop and to route the remaining portion of anode off gas out of the fuel cell system. Where present, the first heat exchanger is prior to the splitter and the second heat exchanger is subsequent to the splitter, and the pump or ejector (if used as the means for controlling the recirculation) is positioned subsequent to the second heat exchanger in the anode off gas recirculation loop. The remaining portion of anode off gas may be routed out of the fuel cell system via a burner to combust any combustible material with oxidant in the cathode off gas. Heat may be recovered from the combustion products by transfer of heat to oxidant in a third heat exchanger and subsequently by transfer of heat to the unreformed hydrocarbon fuel at a fourth heat exchanger, before suitable exhaust, for example via a flue.

Preferably, each cell unit in the stack is separated from an adjacent cell unit by an interconnect structure, the interconnect structure having a coating on a side facing and in fluidic communication with the anode of the adjacent cell unit, the coating comprising a reforming catalyst configured to reform the unreformed hydrocarbon fuel to hydrogen for use in the stack.

In other words, each cell unit may comprise a reforming catalyst, particularly a steam reforming catalyst. The amount of reforming catalyst within the stack (eg within each cell unit) is sufficient to catalyse reformation of the unreformed hydrocarbon fuel, for instance when the unreformed hydrocarbon fuel is provided at a fuel flow rate corresponding to steady state operation.

Preferably, the reforming catalyst is a steam reforming catalyst, for example platinum and/or rhodium. This catalyst may also catalyse cracking during start up above the first threshold temperature when negligible water is present.

Preferably, the electrolyte allows oxygen ion transport. As a result, water is generated at the anode side of the cell units by the fuel cell reaction. Thus, the water generated is a component of the anode off gas and is generated amongst the unreformed hydrocarbon fuel and so may be used in steam reforming the unreformed hydrocarbon fuel. For example, solid oxide fuel cells allow oxygen ion transport.

Preferably, at least one of the anode and the electrolyte comprises ceria. Without being limited by theory, the ceria may be reduced from Ce4+ to Ce3+ during the start-up procedure. The ceria thereby acts as an oxygen source, increasing the O:C ratio and reducing carbon formation. The oxygen released by the ceria also produces steam, used in steam reforming, in the stack, the unreformed hydrocarbon fuel to molecular hydrogen for use by the fuel cell system. Ceria thus allows the fuel cell system to be started without a supply of water or hydrogen to the anode side with minimal carbon deposition at the first threshold temperature. When the O:C ratio increases the ceria may be oxidised to Ce4+, alternatively or additionally, the ceria may be oxidised during a shutdown procedure.

Preferably, the electrolyte is of a type which allows oxygen ion transport, for example a solid oxide fuel cell (SOFC). Water is generated at the anode during fuel cell operation using an electrolyte which allows oxygen ion transport.

Preferably, the anode comprises CGO. CGO may allow the fuel cell system to supply current at a relatively low first threshold temperature.

Preferably, the anode comprises nickel. This may catalyse cracking of the unreformed hydrocarbon fuel to produce hydrogen for use by the fuel cell system at the first threshold temperature. Other components in the fuel cell system may also comprise nickel and thereby catalyse cracking of the unreformed hydrocarbon fuel to produce hydrogen. The other components may, for example, include a metal support plate upon which the electrochemically active layers are coated or deposited or a separator or interconnect plate to separate adjacent cell units.

Preferably, the electrolyte comprises CGO. CGO may allow the fuel cell system to supply current at a relatively low first threshold temperature.

Preferably, the controller is configured to control start-up of the fuel cell system, the controller configured to: control heating of the stack to a first threshold temperature; control supply of unreformed hydrocarbon fuel to the anode inlet, to provide non-zero fuel flow when but not before the controller determines that first threshold temperature is reached; control the flow rate of anode off gas in the anode off gas recirculation loop at a first non-zero flow rate; and to allow current to be drawn from the fuel cell.

As in the method of the first aspect, the controller allows start-up of the fuel cell system using the unreformed hydrocarbon fuel.

Preferably, the controller is further configured to incrementally increase the supply of unreformed hydrocarbon fuel to the anode inlet and incrementally increase the current draw to raise the temperature and current to steady state conditions.

Preferably, the controller is configured to adjust the supply of unreformed hydrocarbon fuel to the anode inlet, flow rate of anode off gas in the anode off gas recirculation loop, and current draw while maintaining voltage of the fuel cell above a threshold voltage.

The threshold voltage is set to prevent damage to the electrochemically active layers (i.e. the anode, electrolyte, and cathode). Electrochemically active layers typically allow current draw at a variety of voltages, but if current is drawn below a certain voltage then damage may be caused to the electrochemically active layers. The voltage threshold ensures damage to the electrochemically active layers is avoided, while also being set to a level that enables current draw at low operating temperatures, thereby providing oxygen to the anode side of the electrolyte, and so allowing the anode to produce oxygen-containing compounds (i.e. water/CO/CO2) from low temperature.

The threshold voltage may be between 0.6 and 0.8V, preferably between 0.7 and 0.8V, more preferably 0.75V. This provides a balance between avoiding damage to the electrochemically active layers and providing current at low temperature (and thereby providing oxygen-containing compounds at the anode to increase the O:C ratio). This may allow the O:C ratio to exceed 2 (preferably 2.2) in a minimal number of steps, for example 2 steps, and to maintain the O:C ratio above 2 (preferably 2.2) as the fuel flow rate of the unreformed hydrocarbon fuel and current draw are increased towards steady state

Additionally or alternatively, the controller is configured to control the fuel flow rate of the unreformed hydrocarbon fuel, flow rate of anode off gas from the anode outlet to the anode inlet, and current draw to bring the ratio of oxygen to carbon in the stack up to above 2 (preferably above 2.2) in a target time period. The target time period is sufficiently short such that any detrimental effect from lack of oxygen can be substantially recovered during steady state operation and/or on shutdown.

Preferably, the controller is configured to control (a) the oxygen to carbon ratio of gas in communication with the anode and (b) the temperature of the stack.

According to an aspect there is provided a controller configured to receive signals indicative of one or both of an anode inlet temperature and anode outlet gas temperature and to control a flow rate of anode off gas through an anode off gas recirculation loop in accordance with the method described above.

### BRIEF DESCRIPTION OF THE DRAWINGS

FIG. 1 is a schematic of a prior art fuel cell system.

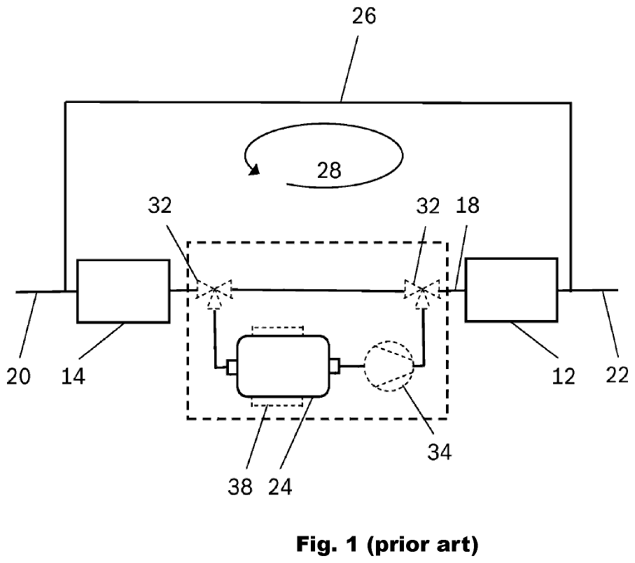

FIG. 2 is a schematic of a fuel cell system in accordance with the present invention.

FIG. 3 is a schematic of a fuel cell system in accordance with the present invention.

FIG. 4 illustrates a start-up procedure in a fuel cell system in accordance with the present invention.

FIG. 5 illustrates a cycle comprising a start-up procedure, steady state operation, and a shutdown procedure in a fuel cell system in accordance with the present invention.

In the following figures and description like reference numerals will be used for like elements in different figures.

### DETAILED DESCRIPTION

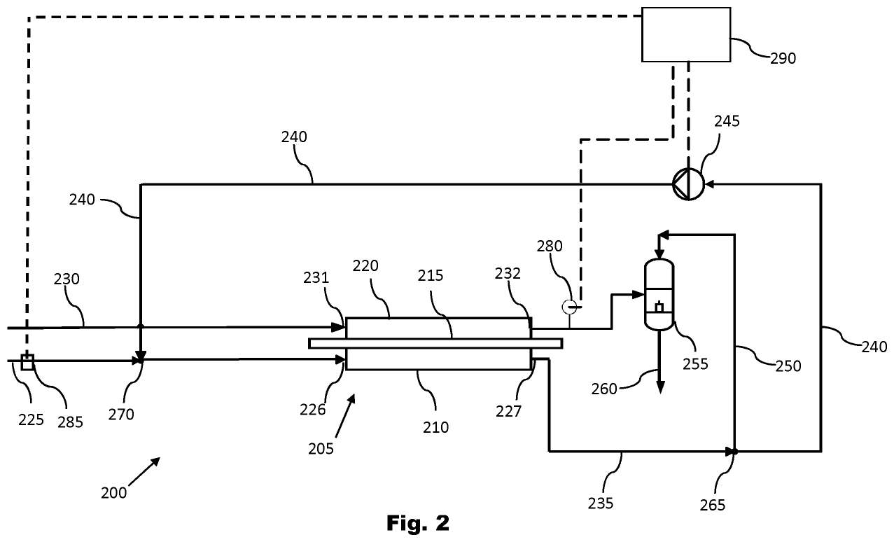

Referring to FIG. 2, a schematic of a fuel cell system 200 is shown. The fuel cell system 200 includes a stack 205 of cell units (only one cell unit is shown for clarity), also referred to as a “cell stack”. A plurality of cell units form the stack of cell units. Each cell unit includes an anode 210, a cathode 220, and an electrolyte 215 positioned between the anode 210 and cathode 220. The anode 210, electrolyte 215, and cathode 220 may together be referred to as the electrochemically active layer, active electrochemical cell layer, or electrochemically active region. The electrolyte 215 conducts either negative oxygen ions or positive hydrogen ions between the anode 210 and cathode 220. A solid oxide fuel cell (SOFC) system that produces electricity is based upon a solid oxide electrolyte that conducts negative oxygen ions from a cathode to an anode located on opposite sides of the electrolyte. For this, a fuel, or reformed fuel, contacts the anode (fuel electrode) and an oxidant, such as air or an oxygen rich fluid, contacts the cathode (air electrode). In fuel cells that have an electrolyte that conducts negative oxygen ions from the cathode to the anode, water is produced by the fuel cell reaction at the anode. Conventional ceramic-supported (e.g. anode-supported) SOFCs have low mechanical strength and are vulnerable to fracture. Hence, metal-supported SOFCs have recently been developed which have the active fuel cell component layer supported on a metal substrate. In these cells, the ceramic layers can be very thin since they only perform an electrochemical function: that is to say, the ceramic layers are not self-supporting but rather are thin coatings/films laid down on and supported by the metal substrate. Such metal supported SOFC stacks are more robust, lower cost, have better thermal properties than ceramic-supported SOFCs and can be manufactured using conventional metal welding techniques. In the example of FIG. 2 the anode 210 may comprise ceria, for example in the form of CGO. The electrolyte 215 may comprise ceria, for example in the form of CGO.

The stack 205 may comprise a stack of planar fuel cell units. The stack of planar cell units may be based on one of solid oxide electrolytes, polymer electrolyte membranes, or molten electrolytes or any other variant capable of electrochemistry. In an example, the stack 205 is based on a plurality of planar cell units (e.g. tens to several hundred cell units) having solid oxide electrolytes and so the fuel cell may be referred to as a solid oxide fuel cell (SOFC). The solid oxide electrolytes may be supported by a foil (not shown), in which case they may be referred to as metal-supported cells, in particular, metal-supported solid oxide fuel cell (MS-SOFC).

Each cell unit may comprise a separator plate and a cell-supporting metal substrate plate (not shown). The metal substrate plate supports the active electrochemical cell layer (i.e. one in which an electrochemical reaction occurs during operation) bonded thereto, which may be coated, deposited or otherwise affixed thereto, and so the cell unit may be referred to as a metal supported cell unit. The separator plate may separate an oxidant fluid volume from a fuel fluid volume in each cell unit of the stack, and will usually be provided with a 3D contoured construction, for example, comprising a pattern of spaced channels and ribs, or spaced dimples, to control fluid flow. The separator plates or interconnects between adjacent cell units in the stack may be coated on the side facing the anode of a given cell unit with a catalyst configured to catalyse steam reforming of unreformed hydrocarbon fuels to produce hydrogen gas within the stack. The reforming catalyst may be referred to as an internal reformer. In an example, each cell unit in the stack is separated from an adjacent cell unit by an interconnect structure (eg the separator and/or interconnect referred to above), the interconnect structure having a coating on a side facing and in fluidic communication with the anode of the adjacent cell unit, the coating comprising the reforming catalyst and configured to reform fuel to hydrogen for use in the stack. The reforming catalyst may be a steam reforming catalyst, for example platinum and/or rhodium. This catalyst may also catalyse cracking during start up above the first threshold temperature when negligible water is present.

Fuel cell system 200 further comprises a fuel inlet 225 which is configured for connection to a supply (not shown) of unreformed hydrocarbon fuel. The fuel inlet 225 provides unreformed hydrocarbon fuel to the anode inlet 226 of the stack 205 for distribution, within the stack 205, to the anode-side (also referred to as fuel volume) of the cell units within the stack 205. Anode outlet 227 of the stack 205 provides an exhaust to the stack and allows removal of fluid from the anode-side of the cell units within the stack 205. The fluid removed from the stack via the anode outlet 227 is referred to as anode off gas. The anode off gas is routed along flow path 235 to a splitter 265. A portion (e.g. a first portion) of the anode off gas from path 235 may be routed around an anode off gas recirculation loop 240 from the anode outlet 227 to the anode inlet 226. In the case shown in FIG. 2, the portion of the anode off gas in the recirculation loop 240 is mixed with unreformed hydrocarbon fuel from the fuel inlet 225 at a mixer 270 which is positioned between the fuel inlet 225 and the anode inlet 226. Means for varying the flow rate of anode off gas in the anode off gas recirculation loop 240 is provided by an ejector or pump 245. The ejector or pump 245 is positioned in the anode off gas recirculation loop 240 between the splitter 265 and the mixer 270.

Anode off gas may also be routed from the splitter 265 via a flow path 250 to a burner 255. The amount of anode off gas routed via flow path 250 may be referred to as a remaining portion of anode off gas (or alternatively a second portion, the sum of the first portion routed to the anode off gas recirculation loop 240 and the second portion routed via the flow path 250 being equal to the total amount of anode off gas in flow path 235. For example, the mass flow rate in the flow path 235 may be equal to the sum of mass flow rates in anode off gas recirculation loop 240 and flow path 250).

Fuel cell system 200 further comprises an oxidant inlet 230, which is configured for connection to a supply of oxidant. The oxidant may, for example, be air or oxygen. The oxidant inlet 230 provides oxidant to the cathode inlet 231 of the stack 205 for distribution, within the stack 205, to the cathode-side (also referred to as oxidant volume) of the cell units within the stack 205.

Cathode outlet 232 of the stack 205 provides an exhaust to the stack 205 and allows removal of fluid from the cathode-side of the cell units within the stack 205. The fluid removed from the stack via the cathode outlet 232 is referred to as cathode off gas. The cathode off gas may be routed to the burner 255.

The burner 255 is configured to combust any remaining combustible fuel in the anode off gas and oxidant in the cathode off gas and route the resultant gasses out of the fuel cell system 200 via exhaust flow path 260. Exhaust path 260 may comprise a flue and may exhaust the resultant gases to atmosphere, after cooling the same.

Fuel cell system 200 further comprises a controller 290 configured to measure parameters of the system and provide outputs to adjust the same. The controller 290 communicates with a means for measuring temperature 280 of the cathode off gas, the means may comprise a thermocouple. The controller may use the temperature of the cathode off gas as an indication of the temperature of the cell units within the stack 205 (it may, for example, be taken as an indication of a minimum temperature within the stack). The controller 290 communicates with the ejector or pump 245, and the controller may control the same to vary the flow rate of anode off gas in the anode off gas recirculation loop 240. The controller also communicates with a means for regulating 285 the supply of unreformed hydrocarbon fuel to the anode inlet 226 from the fuel inlet 225. The means for regulating 285 may comprise a controllable flow restrictor. The controller may thereby control the mass flow rate of unreformed hydrocarbon fuel to the stack 205.

The fuel cell system 200 further comprises means for heating the stack (not shown), which may include an electric heater or combustion of a hydrocarbon fuel at a burner in a manner that will be known to the skilled person. The fuel cell system 200 also includes means for drawing a current (not shown) from the stack 205 and measuring for measuring a voltage (not shown) of the stack 205. The means for drawing a current is in communication with the controller 290, and the controller may limit or otherwise specify a current drawn from the stack 205. The means for measuring a voltage of the stack 205 (and thereby the voltage between the anode and cathode of the cell units) is in communication with the controller 290, which uses the voltage of the stack 205 as one of its inputs.

During a start up procedure of the fuel cell system 200, the controller 290 controls the means for heating to heat the stack 205 to a first threshold temperature, as measured by the means for measuring a temperature 280. Once the stack reaches the first threshold temperature, the controller causes the means for regulating 285 to allow unreformed hydrocarbon fuel to flow from the fuel inlet 225 and be delivered to the anode inlet 226. The unreformed hydrocarbon fuel may comprise one or more of natural gas, methane, ethane, propane, butane, corresponding alcohols, and biogas. It may also be referred to as a pure hydrocarbon fuel (for example by not having added hydrogen or oxygen, i.e., does not have added molecular hydrogen, water, carbon monoxide, or carbon dioxide). The flow rate of the unreformed hydrocarbon fuel may be such that it provides even distribution of unreformed hydrocarbon fuel to the cell units in the stack 205. The controller may now cause the ejector or pump 245 to begin recirculating anode off gas from the anode outlet 227 to the anode inlet 226. The recirculated anode off gas mixes with unreformed hydrocarbon fuel at mixer 270, and as such the fuel supplied to the anode inlet 226 is a mixture of anode off gas provided by the anode off gas recirculation loop 240 and unreformed hydrocarbon fuel provided by the fuel inlet 225. The controller 290 may vary the ejector or pump 245 and the means for regulating 285 to control the relative amounts of unreformed hydrocarbon fuel and recirculated anode off gas at the anode inlet. The proportion of anode off gas recirculated in the anode off gas recirculation loop is up to 80% of the anode off gas in flow path 235 (in other words the first portion is up to 80% and the second portion, in flow path 250, is at least 20%). This prevents build up of excessive amounts of CO and CO2 in the stack.

The first threshold temperature is in the range of 400 to 500 C (in other examples it may be in the range of 400 to 450 C). This is at or above the minimum temperature at which a minimum current can be drawn from the fuel cell without the fuel cell voltage being pulled below a voltage at which damage may occur to the fuel cell (specifically the anode, electrolyte, and cathode). Thus, once the unreformed hydrocarbon fuel supply is started, the controller allows current draw at a first current.

The first temperature is such that cracking of the unreformed hydrocarbon fuel occurs to at least molecular hydrogen (referred to herein as hydrogen) and carbon. Cracking is catalysed by various materials within the stack 205, for example nickel present in metal components. This provides an initial production of hydrogen within the stack.

Without being bound by theory, it is believed that ceria, present in one or both of the anode and electrolyte may be reduced from Ce4+ to Ce3+ during start-up, releasing oxygen to the anode-side of the cell units, this oxygen in the presence of a suitable catalyst being used in steam reforming the unreformed hydrocarbon fuel to contribute to the initially produced hydrogen.

The fuel cell utilises this initially produced hydrogen in the fuel cell reaction, which allows current to be drawn from the stack 205. The fuel cell reaction produces water, in the form of steam, as a by-product. The steam is produced at the anode-side in the stack of FIG. 2 because the electrolyte 215 conducts oxygen ions. Steam at the anode-side is a component of the anode off gas exhausted at the anode outlet 227, which is recirculated to the anode inlet by the anode off gas recirculation loop 240, and supplied to the anode-side of the cell units, where in the presence of a steam reforming catalyst unreformed hydrocarbon fuel may be reformed to hydrogen for use in the fuel cell reaction. The fuel cell reaction is exothermic. This increases the temperature of the stack. As the steam content of the anode off gas increases because of the fuel cell reaction, so too does the steam content provided to the anode inlet by the anode off gas recirculation loop. As a result of the temperature increase, the fuel cell stack voltage increases. As the fuel cell stack voltage increases, the maximum current draw also increases, and the fuel cell is able to receive a greater fuel flow rate of unreformed hydrocarbon fuel at the anode inlet, the controller therefore initiates an increase in the flow rate of unreformed hydrocarbon fuel, this causes a drop in the stack voltage, which is recovered once the temperature of the stack increases (due to the fuel cell reaction).

The voltage and temperature eventually increase from the first temperature and first threshold voltage to steady state operating temperature and voltage conditions. During the start-up procedure, the controller increases the fuel flow rate of unreformed hydrocarbon fuel when the stack voltage reaches a value such that the increase in fuel flow rate does not cause the stack voltage to drop below a minimum. The minimum voltage is one at which damage may occur to the electrochemically active layers of the cell units. As the fuel flow rate of the unreformed hydrocarbon fuel is increased, so too may the current draw and the temperature of the stack. As the temperature of the stack increases, the cell units are able to utilise more fuel, and thereby provide greater current.

Steady state operating conditions, may be characterised by a steady state stack temperature in the range of 400 to 1000 C, preferably 450 to 800 C, preferably 500 to 650 C. Flow rate in the AOGR loop 240 continues at steady state operation, allowing recirculation of steam from the anode outlet to the anode inlet for use at an internal reformer in the stack 205 and allowing re-use of unspent fuel.

The start-up procedure may also include a first step of purging the stack prior to heating the stack. The pre-purge environment is typically old fuel (from last running) at the anode, and air diffused from cathode/exhaust. The purge may use a supply of nitrogen gas. However, it should be understood that a purge is not necessary when operating according to the start-up procedure described herein.

During a shut-down procedure the proportion of anode off gas to unreformed hydrocarbon fuel provided to the anode inlet 226 may be increased in a stepwise or iterative fashion, and the current draw likewise reduced. This results in the temperature of the stack gradually decreasing towards the first threshold temperature. At the first threshold temperature, the supply of unreformed hydrocarbon fuel, flow rate of anode off gas in the AOGR loop 240, and current draw is stopped. The fuel cell system 200 may then be allowed to cool to an off condition (for example cool to ambient temperature) or may be maintained in a dormant condition (for example, at a temperature above ambient by the means for heating), and may subsequently be restarted by the start-up procedure. The shut-down procedure may allow for re-oxidisation of ceria in the anode and/or electrolyte that was reduced during the start-up procedure.

Test data has shown that the fuel cell system 200 may be operated over at least 500 cycles of start-up, steady state, and shut down as described herein with negligible carbon deposit. The procedures describe herein therefore provide for reliable operation of a fuel cell system.

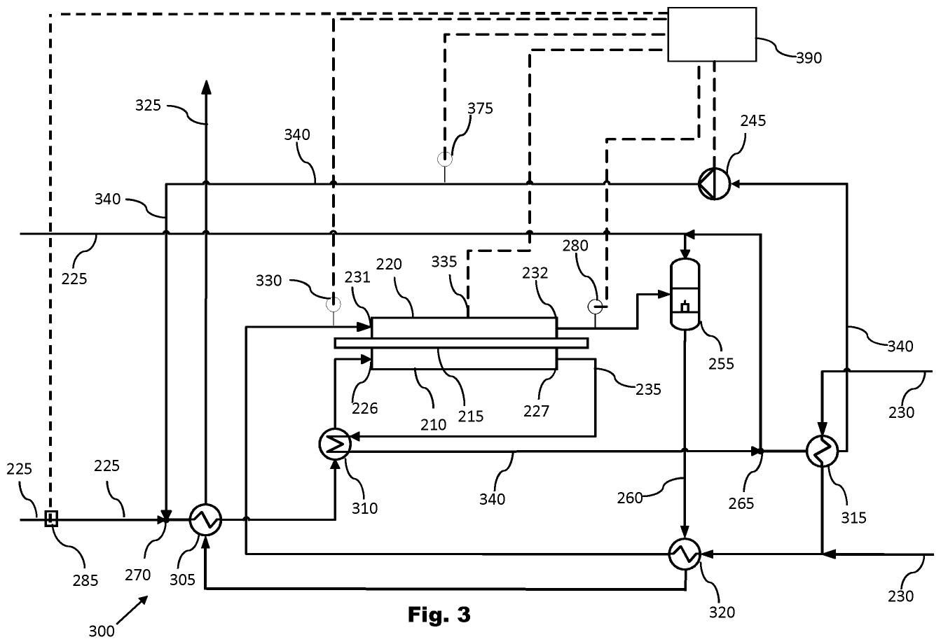

Referring to FIG. 3, a schematic of a fuel cell system 300 is shown. Fuel cell system 300 is a variant of the fuel cell system 200 of FIG. 2, and shows a variety of optional additional features.

The fuel cell system 300 comprises an AOGR loop 340 similar to the AOGR loop 240 of FIG. 2 but which further includes a heater section, comprising at least one heat exchanger. The heater section of FIG. 3 comprises a first heat exchanger 310, sometimes referred to as the secondary fuel heater, a second heat exchanger 315, sometimes referred to as the AOG cooler, a third heat exchanger 305, sometimes referred to as the fuel heater, and a fourth heat exchanger 320, which may be referred to as the air pre-heater.

The first heat exchanger 310 receives anode off gas from the anode outlet 227 via flow path 235 and is configured to transfer heat from the anode off gas to the unreformed hydrocarbon fuel prior to the anode inlet 226. Subsequent to the first heat exchanger 310, the anode off gas is routed to the splitter 265. The portion of anode off gas routed via the AOGR loop 340 is routed from the splitter 265 to the second heat exchanger 315. The second heat exchanger 315 is configured to transfer heat from the anode off gas to oxidant supplied by oxidant inlet 230. Subsequent to the second heat exchanger 315, the anode off gas proceeds around the AOGR loop 340 via the ejector or pump 245 to the mixer 270, similar to the AOGR loop 240 of FIG. 2.

At the mixer 270 (in the anode inlet flow path), anode off gas recirculated via the AOGR loop 340 is mixed with unreformed hydrocarbon fuel from the fuel inlet 225, and may subsequently be passed through the third heat exchanger 305, which is used to transfer heat to the mixture of anode off gas and unreformed hydrocarbon fuel. Subsequently the mixture of anode off gas and unreformed hydrocarbon fuel is passed through the first heat exchanger 310, at which heat is transferred to the mixture from the anode off gas. Subsequently, the mixture is provided to the anode inlet 226.

Referring to the second heat exchanger 315, this heat exchanger is configured to transfer heat from anode off gas in the AOGR loop 340 to oxidant provided by the oxidant inlet 230.

Oxidant heated by the second heat exchanger 315 may be combined with further oxidant from oxidant inlet 230 and routed through the fourth heat exchanger 320.

At the fourth heat exchanger 320, heat is transferred from exhaust gas from burner 255 in exhaust path 260 to the oxidant. Oxidant output from the fourth heat exchanger 320 is routed to the cathode inlet 231. Exhaust gas is routed from the fourth heat exchanger 320 to the first heat exchanger 305, which is configured to transfer heat to the mixture of unreformed hydrocarbon fuel and anode off gas. Subsequently the exhaust gas may be routed out of the system by flow path 325, for example via a flue to atmosphere.

In the above, flow of oxidant may be driven by a fan (not shown) and the flow rate of oxidant through each oxidant path may be driven by one or more fans under the control of the controller 390.

The burner 255 of fuel cell system 300 is provided with an unreformed hydrocarbon top up line, supplied by the fuel inlet 225. This supply may be controlled by the controller 390, and the controller may utilise the burner 255 to combust unreformed hydrocarbon fuel supplied by the top up line as the means for heating the fuel cell system (optionally, in combination with other means for heating such as an electric heater) to the first threshold temperature. In this case, fuel combusted in the burner 255 produces hot exhaust gasses in exhaust path 260, allowing heat to be transferred from the exhaust gas to the oxidant at the fourth heat exchanger 320, that oxidant being routed to the cathode inlet which thereby heats the stack 205.

Fuel cell system 300 may comprise further means for measuring temperature. These may include means for measuring temperature 330 of the cathode inlet gas (in other words the temperature of oxidant delivered to the cathode inlet 231), which may be combined with or alternative to the means for measuring temperature 280 of the cathode off gas. The means for measuring temperature 330 of the cathode inlet gas can be used by the controller 390 to determine the temperature of the stack. The stack temperature may be measured directly by means for measuring temperature 335, this being in communication with the controller 390. Additionally or alternatively, the temperature of anode off gas in the AOGR loop may be measured by means for measuring temperature 375 in communication with the controller 390. The means for measuring temperature 375 is positioned subsequent to the second heat exchanger 315 in the AOGR loop. The means for measuring temperature 375 may be used by the controller 390 to ensure that the temperature of anode off gas in the AOGR loop 340 is not lowered by the second heat exchanger 315 to such an extent that steam in the AOGR loop could condense. For example, the steam in the anode off gas recirculated to the anode inlet may be referred to as “hot”, which may be a temperature above 500 C, or “warm”, which may be a temperature above 120 C. If the controller identifies that the temperature in the AOGR loop is such that steam could condense, then the controller 390 adjusts the oxidant inlets 230 to reduce the amount of oxidant passing through the second heat exchanger 315.

The start-up, steady state, and shut-down procedures described above for the fuel cell system 200 of FIG. 2 apply equally to the fuel cell system 300 of FIG. 3, with the additional, optional, means for heating utilising the burner 255 and fourth heat exchanger 320 already described above.

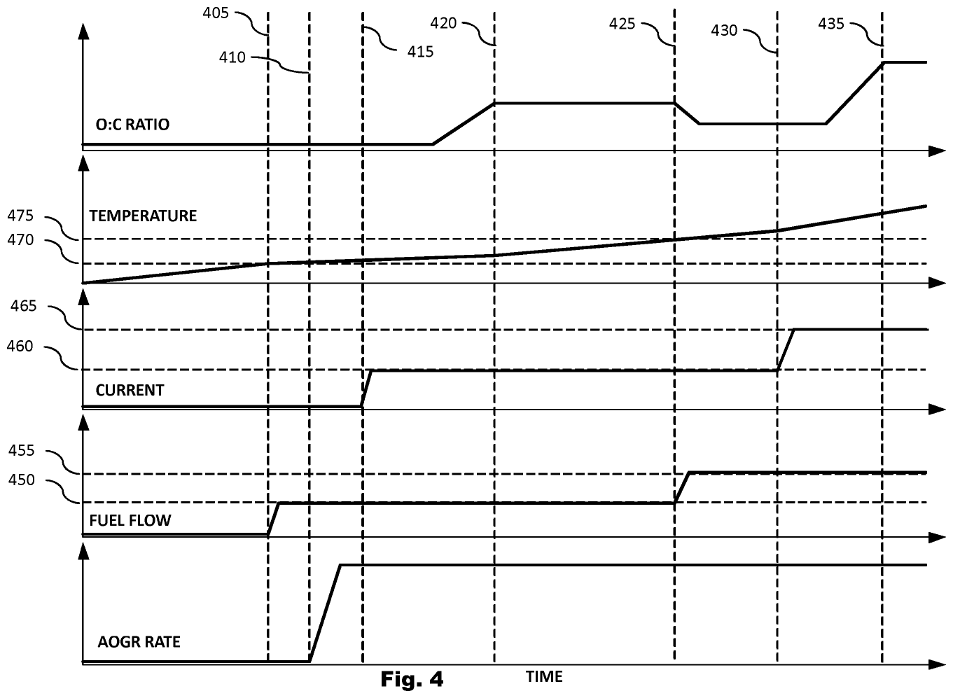

FIG. 4 illustrates a start-up procedure in the fuel cell system 200 of FIG. 2 or 300 of FIG. 3. Initially, the stack is heated (by suitable means) to a first threshold temperature 470 which is reached at time 405. This triggers the controller to allow fuel flow of unreformed hydrocarbon fuel at a first fuel flow rate 450, at (or shortly after) time 405. At time 410, subsequent to time 405, recirculation of anode off gas from the anode off gas outlet to the anode inlet via an AOGR loop is started at a first AOGR flow rate. At time 415, subsequent to time 410, current draw is begun at a first current draw level 460. In some cases, recirculation of anode off gas may begin before or at the same time as fuel is provided (in other words, times 405 and 410 may be the same time). In some cases, current may be drawn before or at the same time as recirculation of anode off gas begins but not before fuel is provided (in other words time 415 may not be earlier than time 405, but time 415 may be the same time as or earlier than time 410).

Current is drawn at the first current draw level 460 from time 415, this means that the fuel cell reaction is proceeding, and thus is producing water, which is recirculated to the anode inlet by the AOGR loop and reaches the anode inlet between times 415 and 420. As a result, the ratio of oxygen to carbon in the gas at the anode-side of the each cell unit begins to increase (from a ratio of zero), resulting in the O:C ratio increase by time 420. Meanwhile, the fuel cell reaction further heats the stack.

At time 425, the stack reaches a second threshold temperature 475 and the controller may therefore increase the fuel flow of unreformed hydrocarbon fuel to a second fuel flow rate 455, greater than the first fuel flow rate 450. This causes a drop in the O:C ratio (because the fuel is unreformed hydrocarbon fuel). At time 430, shortly after time 425, current draw is increased to a second current draw level 465, higher than the first current draw level 460. This is because the temperature and/or O:C ratio are such that the stack can provide a greater current without the stack voltage decreasing below a minimum. As a result of the increased fuel flow, the fuel cell reaction continues at a greater rate and increases the temperature of the stack and thereby increases the O:C ratio to an increased value at time 435.

The process of increasing fuel flow rate and increasing current draw may continue stepwise or under iterative control until steady state operating conditions are reached.

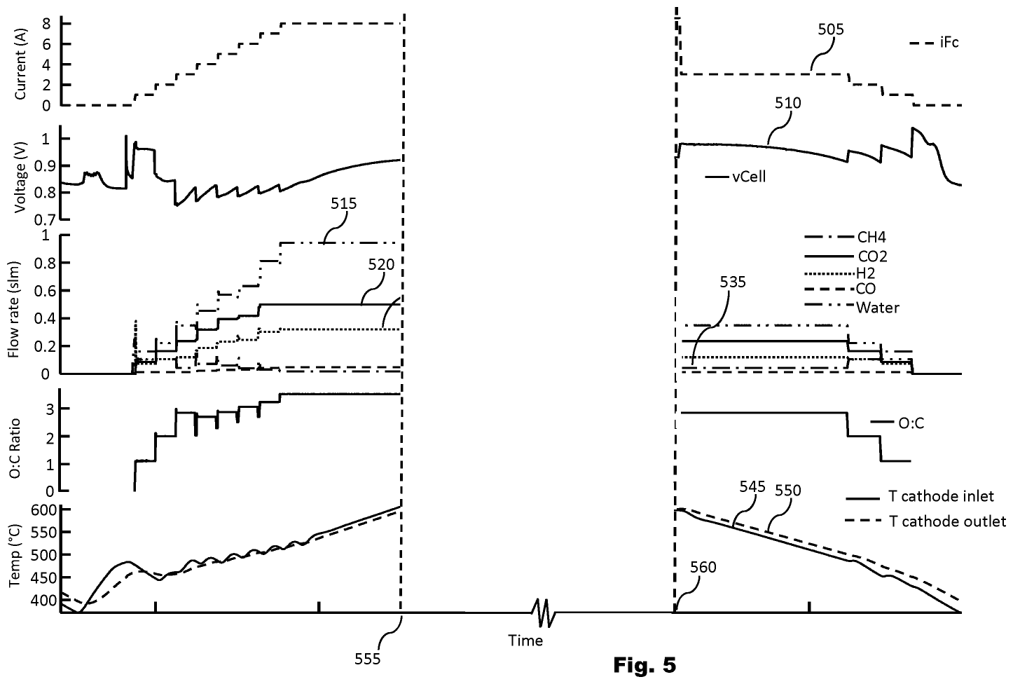

FIG. 5 is test data showing one cycle of start-up, steady state, and shut-down procedures in the fuel cell system 200 of FIG. 2 or 300 of FIG. 3. Said fuel cell systems may be operated over at least 500 cycles of start-up, steady stage, and shut down as described herein with negligible carbon deposit. The procedures describe herein therefore provide for reliable operation of a fuel cell system.

FIG. 5 shows current 505, stack voltage 510, O:C ratio 540, temperature at the cathode inlet 545, temperature at the cathode outlet 550, and relative amounts of water 515, carbon dioxide 520, hydrogen 525, carbon monoxide 530, and unreformed hydrocarbon fuel 535 (in this case predominantly methane) in the anode inlet gas. The O:C ratio is shown on a linear scale but the scale and zero crossing point are likely to vary between systems. Time is shown on the (linear) x-axis relative to an arbitrary start point and the absolute and relative values may vary on a system-by-system basis. The start-up cycle may have a duration of a few hours to 15 hours depending upon system type and size. The steady state may be allowed to run for very much longer.

The first steps of FIG. 5 are similar to the steps described in detail for FIG. 4; initially the stack is heated until it reaches a first threshold temperature, once the first threshold temperature is reached, unreformed hydrocarbon fuel is supplied and recirculation is begun in accordance with FIG. 4 (rate of unreformed hydrocarbon fuel supply and rate in AOGR loop not shown in FIG. 5).

Each time the voltage reaches a certain value, the fuel flow rate and current are increased, resulting in a drop in the voltage. The fuel flow rate and current are incrementally increased each time the voltage reaches the certain value. With each increase there follows a resulting drop in voltage, followed by a recovery in voltage. As the voltage recovers, the current draw can be increased. The amount of each increase in the fuel flow rate is preferably not so large as to cause the stack voltage to drop below threshold or minimum voltage. The current draw is increased each time as soon as possible without the voltage dropping below the threshold. Each increase in current increases the O:C ratio (after an AOG recycling delay) and thereby reduces carbon formation.

At around time 555 a steady state operating temperature, current, and voltage is reached. Between times 555 and 560, the fuel cell system operates in steady state.

At time 560, the shut-down procedure begins. The fuel flow rate of unreformed hydrocarbon fuel is decreased (but not stopped) and the current draw is decreased (but not stopped). As a result, from time 560, the reaction rate of the fuel cell reaction decreases and the stack begins to cool. The stack voltage begins to decrease in correspondence with the temperature. When the stack voltage reaches a certain value, the fuel delivery and current draw are reduced. In turn, the stack voltage increases and the O:C ratio drops because the fuel cell reaction rate is reduced (and thereby less water is produced). This decrease of fuel delivery and current draw is repeated until the current draw reaches the first (minimum non-zero) current draw and the fuel flow rate of unreformed hydrocarbon fuel is at a corresponding minimum rate, once the stack temperature reaches the first threshold voltage, the current draw and fuel flow rate of unreformed hydrocarbon fuel are decreased to zero. The fuel cell system may then be maintained in a standby state (eg a warm state) or allowed to cool to an off state (eg cool to ambient).

The present invention is not limited to the above examples only, and other examples will be readily apparent to one of ordinary skill in the art without departing from the scope of the appended claims.

These and other features of the present invention have been described above purely by way of example. Modifications in detail may be made to the invention within the scope of the claims.

1. A method for operating a fuel cell system, the fuel cell system comprising a plurality of cell units arranged in a stack, each cell unit comprising an anode and a cathode separated by an electrolyte, and the fuel cell system comprising an anode inlet for supply of anode inlet gas to each cell unit and an anode outlet for removal of anode off gas from each cell unit, the method comprising, at start-up of the fuel cell system:
heating the stack to a first threshold temperature;
providing an unreformed hydrocarbon fuel to the anode inlet at a first fuel flow rate from a fuel supply when but not before the stack is above the first threshold temperature;
recirculating anode off gas from the anode outlet to the anode inlet while providing unreformed fuel to the anode inlet; and
drawing a current from the fuel cell system while recirculating the anode off gas.

2. The method of claim 1, further comprising:
monitoring the stack temperature, and when the stack temperature reaches a second threshold temperature, greater than the first threshold temperature, increasing the fuel flow rate of the unreformed hydrocarbon fuel and current draw.

3. The method of claim 1, wherein the current is drawn while maintaining voltage of the fuel cell above a voltage threshold.

4. The method of claim 3, wherein the voltage threshold is between 0.6 and 0.8V

5. The method of claim 1, wherein at least one of the anode and the electrolyte comprises ceria.

6. The method of claim 5, wherein the anode comprises CGO, or wherein the electrolyte comprises CGO.

7. (canceled)

8. The method of claim 1, wherein the unreformed hydrocarbon fuel provided during start-up above the first threshold temperature has the same composition as the unreformed hydrocarbon fuel provided to the anode inlet during steady state operation.

9. The method of claim 1, wherein the first threshold temperature is in the range 400 to 500 C, preferably 400 to 450 C.

10. The method of claim 1, wherein recirculating anode off gas provides water produced by the stack to the anode inlet of the stack, and the method comprises reforming of the unreformed hydrocarbon fuel using the recirculated water at a reforming catalyst positioned between each cell unit and an adjacent cell unit.

11. The method of claim 1, further comprising a shutdown procedure, the shutdown procedure comprising:
reducing the fuel flow rate of the unreformed hydrocarbon fuel and the current draw, while maintaining the stack voltage above a threshold value; and stopping the unreformed hydrocarbon fuel supply when but not before the stack temperature is below the first threshold temperature.

12. (canceled)

13. A fuel cell system comprising:
a plurality of cell units arranged in a stack, each cell unit comprising an anode and a cathode separated by an electrolyte, and the fuel cell system comprising an anode inlet for supply of anode inlet gas to each cell unit and an anode outlet for removal of anode off gas from each cell unit;
means for heating the stack;
means for measuring a temperature of the stack;
a fuel inlet configured for connection to a supply of unreformed hydrocarbon fuel and configured to provide the unreformed hydrocarbon fuel to the anode inlet;
an anode off gas recirculation loop configured to provide a gas flow path to recirculate anode off gas from the anode outlet to the anode inlet;
means for drawing a current from the fuel cell system; and
a controller configured to receive input from the means for measuring and provide output to the recirculation loop and to the means for drawing current, for controlling the recirculation loop, the supply of unreformed hydrocarbon fuel, and the means for drawing current, all in response to the means for measuring.

14. The fuel cell system of claim 13 wherein the anode off gas recirculation loop comprises means configured to vary the flow rate of anode off gas in the anode off gas recirculation loop, controlled by the controller in response to the means for measuring and the means for drawing a current.

15. The fuel cell system of claim 14, wherein the anode off gas recirculation loop further comprises a flowpath for anode off gas from the anode outlet, via a heater section, a mixing section configured to mix anode off gas with unreformed hydrocarbon fuel, and to the anode inlet.

16. The fuel cell system of claim 13, wherein each cell unit in the stack is separated from an adjacent cell unit by an interconnect structure, the interconnect structure having a coating on a side facing and in fluidic communication with the anode of the adjacent cell unit, the coating comprising a reforming catalyst configured to reform the unreformed hydrocarbon fuel to hydrogen for use in the stack.

17. The fuel cell system of claim 13, wherein the electrolyte allows oxygen ion transport.

18. The fuel cell system of claim 13, wherein at least one of the anode and the electrolyte comprises ceria, or wherein the anode comprises CGO, or wherein the electrolyte comprises CGO.

19-20. (canceled)

21. The fuel cell system of claim 13, wherein the controller is configured to control start-up of the fuel cell system, the controller configured to:
control heating of the stack to a first threshold temperature;
control supply of unreformed hydrocarbon fuel to the anode inlet, to provide non-zero fuel flow when but not before the controller determines that first threshold temperature is reached;
control the flow rate of anode off gas in the anode off gas recirculation loop at a first non-zero flow rate; and
to allow current to be drawn from the fuel cell.

22. The fuel cell system of claim 21, wherein the controller is further configured to incrementally increase the supply of unreformed hydrocarbon fuel to the anode inlet and incrementally increase the current draw to raise the temperature and current to steady state conditions.

23. The fuel cell system of claim 21, wherein the controller is configured to adjust the supply of unreformed hydrocarbon fuel to the anode inlet, flow rate of anode off gas in the anode off gas recirculation loop, and current draw while maintaining voltage of the fuel cell above a threshold voltage, and wherein the controller is configured to control (a) the oxygen to carbon ratio of gas in communication with the anode and (b) the temperature of the stack.

24. (canceled)

25. A controller configured to receive signals indicative of one or both of an anode inlet temperature and anode outlet gas temperature and to control a flow rate of anode off gas through an anode off gas recirculation loop in accordance with the method of claim 1.
